(19) United States
(12) Patent Application Publication
(10) Pub. No.: US 2016/0179778 A1
(43) Pub. Date: Jun. 23, 2016

(54) METHOD FOR GENERATING AND RETRIEVING ELECTRONIC DOCUMENT AND RECORDING MEDIUM THEREFOR

(71) Applicant: MTCOM CO., LTD., Seongnam-si, Gyeonggi-do (KR)

(72) Inventor: Seung Bin PAICK, Hwaseong-si, Gyeonggi-do (KR)

(21) Appl. No.: 14/758,662

(22) PCT Filed: Dec. 31, 2013
(86) PCT No.: PCT/KR2013/012416

§ 371 Date: Jun. 30, 2015

(30) Foreign Application Priority Data
Jun. 18, 2013 (KR) 10-2013-0069963

(51) Int. Cl. G06F 17/24; G10L 21/10; G06K 19/06; G06F 3/0484; G06F 3/16

(52) U.S. Cl. CPC G06F 17/243; G06F 3/04842; G06F 3/167; G06K 19/06018; G10L 21/10

(57) ABSTRACT

Provided are a method of generating (and retrieving) an electronic document and a recording medium. According to an embodiment of the present disclosure, an electronic document is generated by allowing a user to input data demanded by respective input boxes of an electronic form by voice and converting the input data into barcodes to facilitate easy retrievals of the data, thereby improving user convenience as compared to a method of generating an electronic document based on manual inputs from a user in the related art.

### TECHNICAL FIELD

The present disclosure relates to a method of generating an electronic document by inputting data required by respective input boxes of an electronic form by voice and converting input data into barcodes to facilitate easy retrievals of the data.

### BACKGROUND ART

As computers and internet have been popularized, more and more transactions using electronic documents are made in various fields, such as banking transactions and transactions between insurance companies and their customers.

Such electronic documents are commonly generated as a user manually inputs corresponding words into respective input boxes of an electronic form including a plurality of input boxes.

However, in this case, electronic documents are generated based on manual inputs using a mouse, a keyboard, a pen recognition, and any of various other input devices, and thus it is inconvenient and time-consuming for a user to generate an electronic document.

Meanwhile, the background art of the present disclosure is disclosed in Korean Patent Laid-Open Gazette No. 10-2012-0087283 (7 Aug. 2012).

### DETAILED DESCRIPTION OF THE INVENTION

### Technical Problem

In view of the above, the present disclosure provides a method of generating (and retrieving) an electronic document, which allows a user to input data demanded by respective input boxes of an electronic form by voice and converts the input data into barcodes to facilitate easy retrievals of the data to generate the electronic document, thereby improving user convenience as compared to a method of generating an electronic document based on manual inputs from a user in the related art.

### Technical Solution

According to a first aspect of the present disclosure, there is provided a method of generating an electronic document by inputting data to one or more respective input boxes included in an electronic form, the method including a displaying operation, in which a display part displays an electronic form including one or more input boxes; an input box selecting operation, in which an input part selects a particular input box of the electronic form; a data inputting operation, in which the input part inputs data with respect to the particular input box by voice; a barcode converting operation, in which the converting part converts voice data input by the voice into a barcode; and an electronic document generating operation, in which a generating part generates an electronic document by relating the converted barcode to the particular input box.

In detail, in the electronic document generating operation, the converted barcode is inserted to the particular input box.

In detail, in the barcode converting operation, the voice data and personalized information is converted into the barcode together.

In detail, in the barcode converting operation, if the voice data and the personalized information are converted into the barcode together, the barcode is converted to the voice data only if information identical to the personalized information is input.

According to a second aspect of the present disclosure, there is provided a method of retrieving an electronic document, the method including a displaying operation, in which a display part displays an electronic document in which barcodes converted from voice data are related to one or more respective input boxes included in an electronic form; an input box selecting operation, in which a converting part selects a particular input box from among the one or more input boxes; a voice data converting operation, in which the converting part converts a barcode related to the selected particular input box to voice data; and an outputting operation, in which an output part outputs the converted voice data.

In detail, the voice data converting operation includes determining whether the barcode is generated based on personalized information besides the voice data; if the barcode is generated based on personalized information besides the voice data, requesting a retriever to input the personalized information; and, only if the personalized information is input by the retriever, converting the barcode to the voice data.

In detail, the method further includes an operation in which a determining part compares the output voice data to a person's actual voice data, who is named as the generator of the electronic document, and determines whether the electronic document is a genuine electronic document generated by the person named as the generator of the electronic document.

### Advantageous Effects

As described above, in a method of generating (and retrieving) an electronic document according to an embodiment of the present disclosure, an electronic document is generated by allowing a user to input data demanded by respective input boxes of an electronic form by voice and converting the input data into barcodes to facilitate easy retrievals of the data, thereby improving user convenience as compared to a method of generating an electronic document based on manual inputs from a user in the related art.

### DESCRIPTION OF THE DRAWINGS

FIG. 1 is a schematic diagram illustrating an electronic document generating (and retrieving) system according to an embodiment of the present disclosure;

FIG. 2 is a schematic diagram illustrating a generating device according to an embodiment of the present disclosure;

FIG. 3 is a schematic diagram illustrating a retrieving device according to an embodiment of the present disclosure;

FIG. 4 is a diagram for describing the structure of an electronic document according to an embodiment of the present disclosure;

FIG. 5 is a schematic flowchart for describing a flow of operations in a generating device according to another embodiment of the present disclosure; and

FIG. 6 is a schematic flowchart for describing a flow of operations in a retrieving device according to another embodiment of the present disclosure.

### MODE OF THE INVENTION

Hereinafter, the present disclosure will be described in detail by explaining preferred embodiments of the present disclosure with reference to the attached drawings.

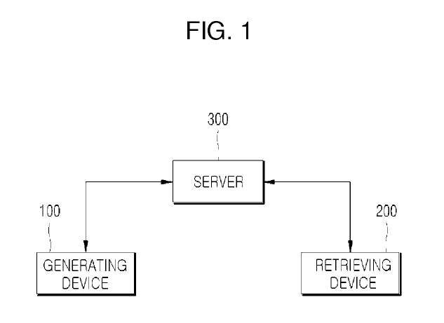

FIG. 1 is a diagram illustrating an electronic document generating (and retrieving) system according to an embodiment of the present disclosure.

As illustrated in FIG. 1, the electronic document generating (and retrieving) system according to an embodiment of the present disclosure includes a generating device 100 for generating an electronic document and a retrieving device 200 for retrieving the generated electronic document.

Furthermore, the electronic document generating (and retrieving) system according to an embodiment of the present disclosure may further include a server 300 for storing electronic documents other than the above-stated components.

Here, the generating device 100 refers to a device that provides an electronic form including a plurality of input boxes, receives data corresponding to the input boxes, and generates an electronic document.

The generating device 100 as described above may perform a series of operations for providing an electronic form and generating an electronic document by executing an application.

In view of the above, the generating device 100 may be a user device capable of executing applications and may be a smart phone, a personal computer (PC), a laptop PC, a tablet PC, or a personal digital assistant (PDA), for example.

Furthermore, the retrieving device 200 refers to a device for retrieves an electronic document stored in the server 300 and checking data input to the electronic document.

Like the generating device 100, the retrieving device 200 may perform a series of operations for retrieving an electronic document and checking input data by executing an application.

Therefore, the retrieving device 200 refers to a user device capable of executing applications like the generating device 100.

Furthermore, the server 300 refers to a service functions as a data storage for storing electronic documents.

The server 300 receives and stores electronic documents generated by the generating device 100, so that the retrieving device 200 may retrieve the stored electronic documents.

Meanwhile, according to an embodiment of the present disclosure, an electronic form including a plurality of input boxes is provided to a user, such that the user inputs data demanded by the electronic form, thereby generating an electronic document instead of a paper form for environment-friendliness.

Here, an electronic form includes a plurality of input boxes to receive inputs of data from a user.

Such input boxes may demand data corresponding to personal information regarding a user, such as a name, a resident registration number, and an address, and various other data based on types of electronic documents, such as an advice from a counselor.

Here, a user generally inputs data demanded by an electronic form by using various input devices supported by the generating device 100, e.g., a mouse, a keyboard, a pen recognition, and various other input devices.

However, although such an electronic document generating method satisfies environment-friendliness by being paperless, if a user is not familiar with the generating device 100, it is more inconvenient than using a conventional paper form, and thus it may take a significant time period to input data.

Therefore, according to the present embodiment, a method of generating an electronic document by allowing a user to input data demanded by the respective input boxes by voice and converting the input data into barcodes to facilitate easy retrievals of the data is suggested. Detailed descriptions thereof will be given below.

The generating device 100 performs a function of displaying an electronic form.

In detail, the generating device 100 reads out an electronic form demanded by a user from among electronic forms in various formats (e.g., PDF, an image, CSD, etc.) that are generated in advance to include a plurality of input boxes from an integrated or separate storage part and converts the read-out electronic form into a bitmap, thereby displaying the electronic form.

Furthermore, the generating device 100 performs a function of inputting data demanded by the electronic form.

In detail, while the generating device 100 is displaying an electronic form demanded by a user, if a voice input button (not illustrated) being displayed in relation to a particular input box is selected by a user, the generating device 100 inputs data received with respect to the particular input box in the form of voice to the corresponding input box.

Furthermore, the generating device 100 performs a function for converting input data.

In detail, when an input of voice data demanded by a particular input box is completed, the generating device 100 converts the voice data into barcodes, so that the barcodes may be retrieved via the retrieving device 200.

Here, if voice data of a user and personalized information for data security are input to the corresponding input box, the generating device 100 performs a barcode conversion for a barcode to include the personalized information, so that the personalized information may be utilized later as key information for converting the barcode to voice data at the retrieving device 200.

Furthermore, the generating device 100 performs a function of generating an electronic document.

In detail, when barcode conversions regarding voice data and personalized information input with respect to respective input boxes are completed, the generating device 100 relates (e.g., inserts) the converted barcodes in correspondence to respective input boxes included in an electronic form, thereby generating an electronic document in which data inputs are completed with respect to the respective input boxes.

Furthermore, the generating device 100 transmits an electronic document.

In detail, when generation of an electronic document is completed by relating converted barcodes with respect to respective input boxes, the generating device 100 transmits the generated electronic document to the server 300, so that the server 300 stores the electronic document. Therefore, the retrieving device 200 may retrieve the electronic document stored in the server 300.

The retrieving device 200 performs a function for receiving and displaying an electronic document.

In detail, the generating device 100 receives a stored electronic document from the server 300 and decodes the electronic document, thereby displaying an electronic document to which barcodes converted to correspond to respective input boxes on a display screen.

Furthermore, the retrieving device 200 performs a function for converting barcodes to voice data.

In detail, when a user selects a particular input box being displayed on a display screen, the retrieving device 200 reads and analyzes a barcode inserted to the selected input box, thereby converting the corresponding barcode to a user's voice data corresponding to the input box.

Furthermore, the retrieving device 200 performs a function for outputting voice data.

In detail, when a barcode is converted to voice data, the retrieving device 200 outputs the converted voice data, so that a retriever may listen to the voice data.

Furthermore, the retrieving device 200 performs a function for determining whether a retriever is a person who is named as the actual generator of a corresponding electronic document.

In detail, the retrieving device 200 instructs a retriever to input voice and compares the input voice of the retriever to converted voice data, thereby determining whether the retriever is a person who is named as the actual generator of a corresponding electronic document.

Here, if it is confirmed that the input voice of the retriever and the converted voice data are identical to each other, the retrieving device 200 determines the retriever as the person who is named as the actual generator of the corresponding electronic document. Therefore, even if the person who is named as the actual generator of the corresponding electronic document denies generation of the electronic document later, it may be easily determined whether the person's denial is true.

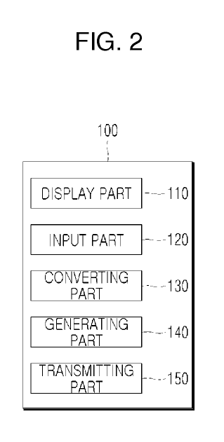

Hereinafter, referring to FIG. 2, a configuration of the generating device 100 according to an embodiment will be described in closer details.

In other words, the generating device 100 includes a display part 110 for displaying an electronic form, an input part 120 for inputting voice data, a converting part 130 for barcode conversion, a generating part 140 for generating an electronic document, and a transmitting part 150 for transmitting a generated electronic document to the server 300.

Here, the respective components of the generating device 100 including the display part 110, the input part 120, the converting part 130, and the generating part 140 may be embodied as software modules in the form of applications to be executed by a processor or combinations thereof.

The display part 110 performs a function for displaying an electronic form.

In detail, the display part 110 reads out an electronic form demanded by a user from among electronic forms in various formats (e.g., PDF, an image, CSD, etc.) that are generated in advance to include a plurality of input boxes from an integrated or separate storage part and converts the read-out electronic form into a bitmap, thereby displaying the electronic form.

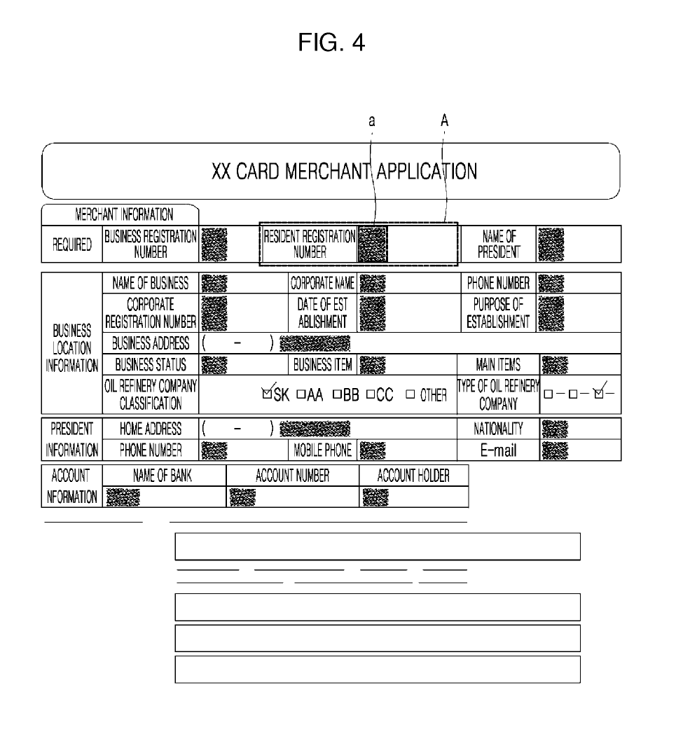

Here, as illustrated in FIG. 4, the electronic form includes a plurality of input boxes A demanding data inputs from a user, where a voice input button (not illustrated) for inputting data by voice is displayed with respect to each of the input boxes A in a form to be selected by using a mouse or a finger.

The input part 120 performs a function for inputting data demanded by an electronic form.

In detail, while an electronic form demanded by a user is being displayed, if a voice input button related to a particular input box is selected by a user, the input part 120 inputs data received with respect to the particular input box in the form of voice to the corresponding input box.

Here, the input part 120 may receive personalized information for data security (e.g., a password) from the user and input the personalized information and data received from the user by voice to the corresponding input box together.

Here, identification information may be allocated to the respective input boxes included in the electronic document, and thus voice data and personalized information that are received from the user in correspondence to the respective input boxes may be input by being mapped to the respective identification information regarding the input boxes.

The converting part 130 performs a function for converting input data.

(*70) In detail, when voice data demanded by a particular input box is input, the converting part 130 converts the voice data into a barcode to be retrieved at the retrieving device 200.

Here, if the voice data of a user and personalized information for data security are input to the corresponding input box together, the converting part 130 performs a barcode conversion for a barcode to include the personalized information, so that the personalized information may be utilized later as key information for converting the barcode to voice data at the retrieving device 200.

For example, in the case of an input box for inputting personal information requiring security, such as a ‘resident registration number,’ the converting part 130 may convert data input to the corresponding input box and personalized information (e.g., a password) into a barcode together, such that it is necessary to input an accurate password to convert the corresponding barcode to voice data later. Therefore, security of personal information may be further improved.

Here, although general barcodes, such as 1D, 2D, and 3D, are utilized, 2D and 3D barcodes may be preferentially utilized for conversion of voice data.

The generating part 140 performs a function for generating an electronic document.

In detail, when barcode conversions regarding voice data and personalized information input with respect to respective input boxes are completed, the generating part 140 relates (e.g., inserts) the converted barcodes in correspondence to respective input boxes included in an electronic form, thereby generating an electronic document in which data inputs are completed with respect to the respective input boxes.

For example, as illustrated in FIG. 4, the generating part 140 may generate an electronic document by relating an input box into a barcode by inserting a converted barcode a to a corresponding input box A.

Furthermore, the transmitting part 150 performs a function for transmitting an electronic document.

In detail, when generation of an electronic document is completed by relating converted barcodes with respect to respective input boxes, the transmitting part 150 transmits the generated electronic document to the server 300, so that the server 300 stores the electronic document. Therefore, the retrieving device 200 may retrieve the electronic document stored in the server 300.

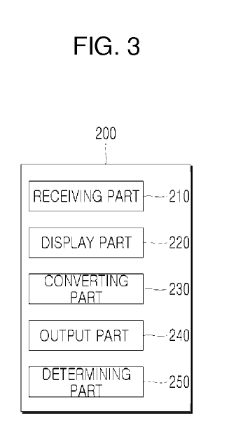

Hereinafter, referring to FIG. 3, a configuration of the retrieving device 200 according to an embodiment will be described in closer details.

In other words, the retrieving device 200 includes a receiving part 210 for retrieving and receiving an electronic document, a display part 220 for displaying an electronic document, a converting part 230 for converting barcodes to voice data, an output part 240 for outputting converted voice data, and a determining part 250 for determining whether a retriever of an electronic document is identical to a person generated the electronic document.

Here, the respective components of the retrieving device 200 including the receiving part 210, the display part 220, the converting part 230, the output part 240, and the determining part 250 may be embodied as software modules in the form of applications to be executed by a processor or combinations thereof.

The display part 220 performs a function for receiving and displaying an electronic document.

In detail, the display part 220 decodes an electronic document received via the receiving part 210 from the server 300, thereby displaying an electronic document to which barcodes converted to correspond to respective input boxes on a display screen.

The converting part 230 performs a function for converting barcodes to voice data.

In detail, when a user selects a particular input box being displayed on a display screen, the converting part 230 reads and analyzes a barcode inserted to the selected input box, thereby converting the corresponding barcode to a user's voice data corresponding to the input box.

Here, the converting part 230 determines whether the barcode inserted to the input box selected by the user includes personalized information before converting the barcode to voice data.

Here, if it is determined that the barcode inserted to the input box selected by the user includes personalized information, the converting part 230 instructs a user retrieving the electronic document, that is, a retriever to input personalized information for voice data conversion.

In related thereto, the converting part 230 performs conversion of the barcode to voice data only if it is confirmed that personalized information input by the retriever is identical to the personalized information included in the barcode.

The output part 240 performs a function for outputting voice data.

In detail, when a barcode is converted to voice data, the output part 240 outputs the converted voice data, so that a retriever may listen to the voice data.

The determining part 250 performs a function for determining whether a retriever is a person who actually generated a corresponding electronic document.

In detail, the determining part 250 instructs a retriever to input voice and compares the input voice of the retriever to converted voice data, thereby determining whether the retriever is a person who is named as the actual generator of a corresponding electronic document.

Here, if it is confirmed that the input voice of the retriever and the converted voice data are identical to each other, the determining part 250 determines the retriever as the person who is named as the actual generator of the corresponding electronic document.

For example, if an electronic document indicates that a person generated the electronic document is ‘Hong, Gil-Dong’ and an actual voice of ‘Hong, Gil-Dong’ is identical to an output voice, it may be determined that the electronic document is a genuine electronic document generated by the ‘Hong, Gil-Dong’ who is indicated as the generator of the electronic document. If the actual voice of ‘Hong, Gil-Dong’ is identical to an output voice, it may be determined that the electronic document is forged by a third person.

Therefore, even if the person who actually generated an electronic document denies generation of the corresponding electronic document later, it may be easily determined whether the person's denial is true.

As described above, the electronic document generating (and retrieving) system according to an embodiment of the present disclosure generates an electronic document by allowing a user to input data demanded by respective input boxes of an electronic form by voice and converting the input data into barcodes to facilitate easy retrievals of the data, thereby improving user convenience as compared to a generation of an electronic document based on manual inputs from a user in the related art. Furthermore, security of data input to an electronic document may be improved by setting additional personalized information (e.g., passwords) with respect to respective input boxes and converted into barcodes and instructing to input the personalized information during a retrieval of the electronic document later.

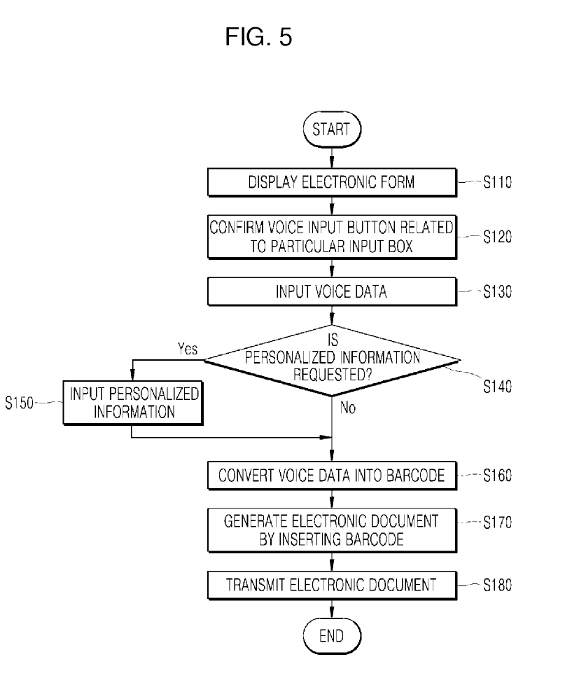

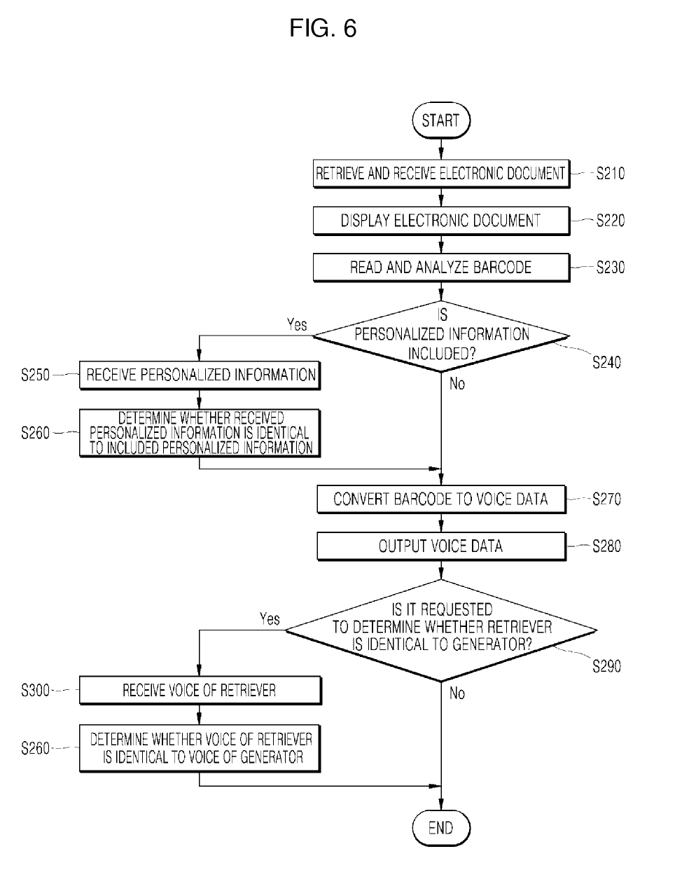

Hereinafter, referring to FIGS. 5 and 6, a method of generating (and retrieving) an electronic document according to an embodiment of the present disclosure will be described.

Here, for convenience of explanation, the components illustrated in FIGS. 2 and 3 will be denoted by the same reference numerals.

First, referring to FIG. 5, a flow of operations at the generating device 100 for generating an electronic document according to an embodiment of the present disclosure will be described.

First, a display part 110 reads out an electronic form demanded by a user from among electronic forms in various formats (e.g., PDF, an image, CSD, etc.) that are generated in advance to include a plurality of input boxes from an integrated or separate storage part and converts the read-out electronic form into a bitmap, thereby displaying the electronic form (operation S110).

Next, while an electronic form demanded by a user is being displayed, if a voice input button related to a particular input box is selected by a user, the input part 120 inputs data received with respect to the particular input box in the form of voice to the corresponding input box (operations S120 and S130).

Here, the input part 120 may receive personalized information for data security (e.g., a password) from the user and input the personalized information and data received from the user by voice to the corresponding input box together (operations S140 and S150).

Next, when voice data demanded by a particular input box is input, the converting part 130 converts the voice data into a barcode to be retrieved at the retrieving device 200 (operation S160).

Here, if the voice data of a user and personalized information for data security are input to the corresponding input box together, the converting part 130 performs a barcode conversion for a barcode to include the personalized information, so that the personalized information may be utilized later as key information for converting the barcode to voice data at the retrieving device 200.

Next, when barcode conversions regarding voice data and personalized information input with respect to respective input boxes are completed, the generating part 140 relates (e.g., inserts) the converted barcodes in correspondence to respective input boxes included in an electronic form, thereby generating an electronic document in which data inputs are completed with respect to the respective input boxes (operation S170).

Next, when generation of an electronic document is completed by relating converted barcodes with respect to respective input boxes, the transmitting part 150 transmits the generated electronic document to the server 300, so that the server 300 stores the electronic document. Therefore, the retrieving device 200 may retrieve the electronic document stored in the server 300 (operation S180).

Next, referring to FIG. 6, a flow of operations at the retrieving device 200 for retrieving an electronic document according to an embodiment of the present disclosure will be described.

First, the display part 220 decodes an electronic document received via the receiving part 210 from the server 300, thereby displaying an electronic document to which barcodes converted to correspond to respective input boxes on a display screen (operations S210 and S220).

Next, when a user selects a particular input box being displayed on a display screen, the converting part 230 reads and analyzes a barcode inserted to the selected input box, thereby converting the corresponding barcode to a user's voice data corresponding to the input box (operations S230, S240, and S270).

Here, the converting part 230 determines whether the barcode inserted to the input box selected by the user includes personalized information before converting the barcode to voice data (operations S240 to S270).

Here, if it is determined that the barcode inserted to the input box selected by the user includes personalized information, the converting part 230 instructs a user retrieving the electronic document, that is, a retriever to input personalized information for voice data conversion.

In related thereto, the converting part 230 performs conversion of the barcode to voice data only if it is confirmed that personalized information input by the retriever is identical to the personalized information included in the barcode.

Next, when a barcode is converted to voice data, the output part 240 outputs the converted voice data, so that a retriever may listen to the voice data (operation S280).

Next, if is demanded to determine whether a retriever is a person who is named as the actual generator of a corresponding electronic document, the determining part 250 instructs the retriever to input voice and compares the input voice of the retriever to converted voice data, thereby determining whether the retriever is the person who is named as the actual generator of the corresponding electronic document (operations S290 to S310).

Here, if it is confirmed that the input voice of the retriever and the converted voice data are identical to each other, the determining part 250 determines the retriever as the person who is named as the actual generator of the corresponding electronic document. Therefore, even if the person who is named as the actual generator of an electronic document denies generation of the corresponding electronic document later, it may be easily determined whether the person's denial is true.

As described above, in the method of generating (and retrieving) an electronic document according to an embodiment of the present disclosure, an electronic document is generated by allowing a user to input data demanded by respective input boxes of an electronic form by voice and converting the input data into barcodes to facilitate easy retrievals of the data, thereby improving user convenience as compared to a method of generating an electronic document based on manual inputs from a user in the related art. Furthermore, security of data input to an electronic document may be improved by setting additional personalized information (e.g., passwords) with respect to respective input boxes and converted into barcodes and instructing to input the personalized information during a retrieval of the electronic document later.

Incidentally, the method and steps of the algorithm described above related to the embodiments of the present disclosure may be realized in the form of hardware, software executed by a processor, or a combination of hardware and software. The software module may reside in a storage medium, such as a RAM memory, a flash memory, a ROM memory, an EPROM memory, an EEPROM memory, registers, a hard disc, a mobile disc, a CD-ROM, or other storage devices generally known in the art. The storage medium is connected to the processor, so that the processor may read information from the storage medium or record the information onto the storage medium. Alternatively, the storage medium can be integrated in the processor. The processor and the storage medium may be included in an ASIC. The ASIC may be included in the terminal. Alternatively, the processor and the storage medium may serve as components of the terminal.

Although the exemplary embodiments of the present disclosure have been described, it is understood that the present disclosure should not be limited to these exemplary embodiments but various changes and modifications can be made by one ordinarily skilled in the art within the spirit and scope of the present disclosure as hereinafter claimed.

### INDUSTRIAL APPLICABILITY

In a method of generating (and retrieving) an electronic document and a recording medium according to an embodiment of the present disclosure, an electronic document is generated by allowing a user to input data demanded by respective input boxes of an electronic form by voice and converting the input data into barcodes to facilitate easy retrievals of the data. Thus, the present disclosure overcomes the problems occurring in the prior art, so that the present disclosure is applicable in various fields in terms of sales and business and very useful in practice with higher industrial applicability.

1. A method of generating an electronic document by inputting data to one or more respective input boxes included in an electronic form, the method comprising:
displaying, by a display part, an electronic form comprising one or more input boxes;
selecting, by an input part, one of the input boxes in the electronic form;
inputting, by the input part, voice data to the selected input box;
converting, by a converting part, the voice data into a barcode; and
generating, by a generating part, an electronic document by relating the converted barcode to the particular input box.

2. The method of claim 1, wherein, the generating comprises inserting the converted barcode into the particular input box.

3. The method of claim 1, wherein the converting comprises converting the voice data and personalized information into the barcode together.

4. The method of claim 3, wherein, if the voice data and the personalized information are converted into the barcode together in the converting, the barcode is converted to the voice data only if input information is identical to the personalized information.

5. A method of retrieving an electronic document, the method comprising:
displaying, by a display part, an electronic document in which barcodes converted from voice data are related to one or more respective input boxes included in an electronic form;
selecting, by a converting part, a particular input box from among the one or more input boxes;
converting, by the converting part, a barcode related to the selected particular input box into voice data; and
outputting, by an output part, the converted voice data.

6. The method of claim 5, wherein the converting comprises:
determining whether the barcode is generated based on personalized information besides the voice data;
if the barcode is generated based on personalized information besides the voice data, requesting a retriever to input the personalized information; and
only if the personalized information is input by the retriever, converting the barcode to the voice data.

7. The method of claim 5, further comprising comparing, by a determining part, the output voice data with a person's actual voice data, who is named as the actual generator of the electronic document, to determine whether the electronic document is actually generated by the person.

8. A non-transitory computer readable recording medium having stored thereon a computer program for implementing the method of any one of claim 1.

9. A non-transitory computer readable recording medium having stored thereon a computer program for implementing the method of any one of claim 2.

10. A non-transitory computer readable recording medium having stored thereon a computer program for implementing the method of any one of claim 3.

11. A non-transitory computer readable recording medium having stored thereon a computer program for implementing the method of any one of claim 4.

12. A non-transitory computer readable recording medium having stored thereon a computer program for implementing the method of any one of claim 5.

13. A non-transitory computer readable recording medium having stored thereon a computer program for implementing the method of any one of claim 6.

14. A non-transitory computer readable recording medium having stored thereon a computer program for implementing the method of any one of claim 7.
